(19) United States
(12) Patent Application Publication
(10) Pub. No.: US 2006/0102687 A1
(43) Pub. Date: May 18, 2006

(54) Fastener Device

(76) Inventors: John W. Schnell, Anderson, SC (US); Daniel Paxton Wall, Humboldt, TN (US)

Correspondence Address: THE BLACK & DECKER CORPORATION, 701 EAST JOPPA ROAD, TW199, TOWSON, MD, 21286, US

(21) Appl. No.: 11/193,041

(22) Filed: Jul. 29, 2005

Related U.S. Application Data
(60) Provisional application No. 60/592,004, filed on Jul. 29, 2004.

(51) Int. Cl. B25C 1/04

(52) U.S. Cl. 227/130; 227/120

(57) ABSTRACT

A fastener device has a main housing portion including a first side and a second side generally opposite the first side, with at least one of the first and second sides being generally open for receiving internal components of the fastener device within the main housing portion during assembly of the fastener device. A first side housing portion is attached to an open side of the main housing portion for at least substantially covering the open side of the main housing portion. A second side housing portion may be attached to a second open side of the main housing portion for at least substantially covering the second open side of the main housing portion. The main housing portion, the first side housing portion, and possibly the second side housing portion substantially enclose the internal components after assembly of the fastener device.

### CROSS-REFERENCE TO RELATED APPLICATIONS

The present application claims the benefit under 35 U.S.C. § 119(e) of U.S. Provisional Application Ser. No. 60/592,004, filed Jul. 29, 2004, which is herein incorporated by reference in its entirety.

### FIELD OF THE INVENTION

The present invention generally relates to the field of fastener devices such as pneumatic nailers and staplers, combustion nailers and staplers, and the like, and more particularly to a fastener device having a housing that facilitates efficient assembly of the fastener device during manufacturing.

### BACKGROUND OF THE INVENTION

Fastener devices, such as pneumatic nailers and staplers, combustion nailers and staplers, and the like, generally include a single-piece housing that is cast from aluminum. Internal components of the fastener device are assembled and installed within this housing during manufacture of the device. For example, a pneumatic nailer may include an intake channel or duct, a trigger valve cylinder, a transfer channel, and a power cylinder. Each of these components must be individually manufactured and then installed within the housing of the pneumatic nailer. The fastener (nail) magazine must also be attached to the housing.

Because the internal components of such fastener devices must be inserted within the housing, assembly of the devices is inefficient. The installation of each component adds a step to the assembly process. For every step in the assembly process, the cost of manufacturing the fastener device increases.

Consequently, it would be desirable to provide a fastener device having a housing that facilitates efficient assembly of the fastener device during manufacturing.

### SUMMARY OF THE INVENTION

Accordingly, the present invention is directed to a fastener device having a main housing portion including a first side and a second side generally opposite the first side, with at least one of the first and second sides being generally open for receiving internal components of the fastener device within the main housing portion during assembly of the fastener device. A first side housing portion is attached to an open side of the main housing portion for at least substantially covering the open side of the main housing portion. If the main housing portion includes a second open side, a second side housing portion is attached to the second open side of the main housing portion for at least substantially covering the second open side of the main housing portion. Thus, the main housing portion, the first side housing portion, and possibly the second side housing portion substantially enclose the internal components after assembly of the fastener device.

A method for manufacturing a fastener device includes the steps of molding a main housing portion, the main housing portion having a side generally open for receiving internal components of the fastener device within the main housing portion during assembly of the fastener device; assembling the internal components into the main housing portion; and attaching a side housing portion to the main housing portion for at least substantially covering the open side of the main housing portion. In this manner, the side housing portion substantially encloses the internal components within the main housing portion after assembly of the fastener device.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an isometric view illustrating a fastener device in accordance with an exemplary embodiment of the present invention;

FIG. 2 is a partial isometric view of the fastener device illustrated in FIG. 1;

FIG. 3 is a partial side view of the fastener device illustrated in FIG. 1;

FIG. 4 is an exploded isometric view of the fastener device illustrated in FIG. 1;

FIG. 5 is an isometric view of a main housing portion for the fastener device illustrated in FIG. 1;

FIG. 6 is an isometric view of the main housing portion illustrated in FIG. 5;

FIG. 7 is an exploded isometric view illustrating a fastener device in accordance with another exemplary embodiment of the present invention;

FIG. 8 is an exploded isometric view illustrating a fastener device in accordance with a further exemplary embodiment of the present invention; and

FIG. 9 is a block diagram illustrating a method of manufacturing a fastener device in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

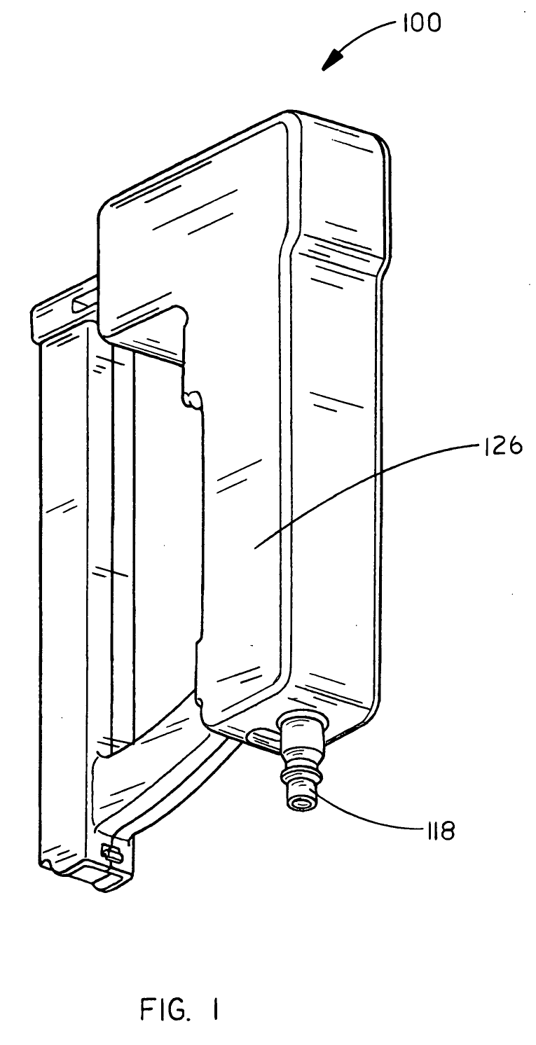

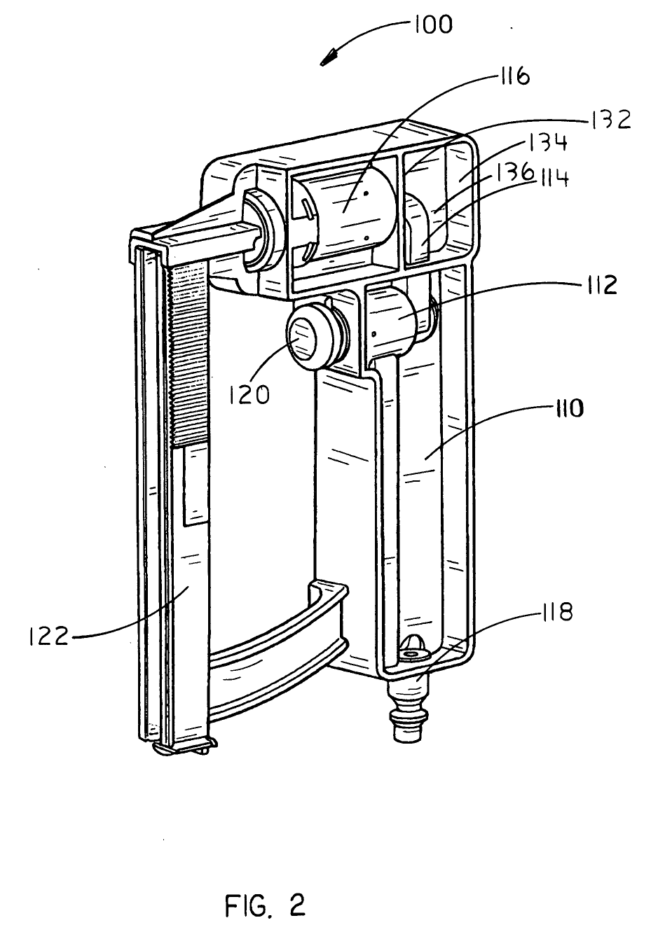

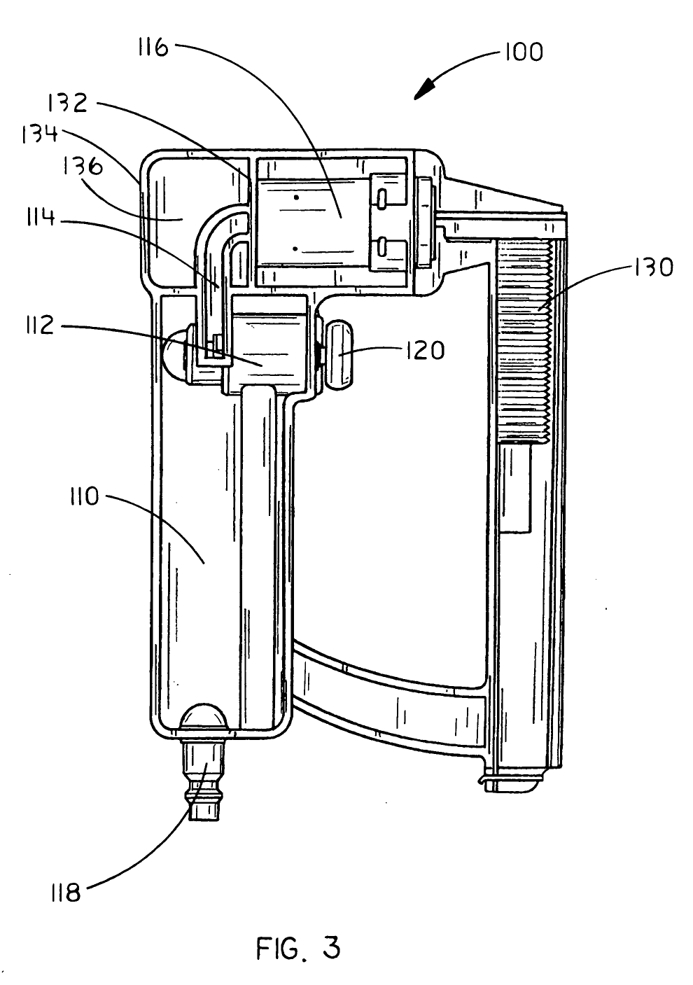

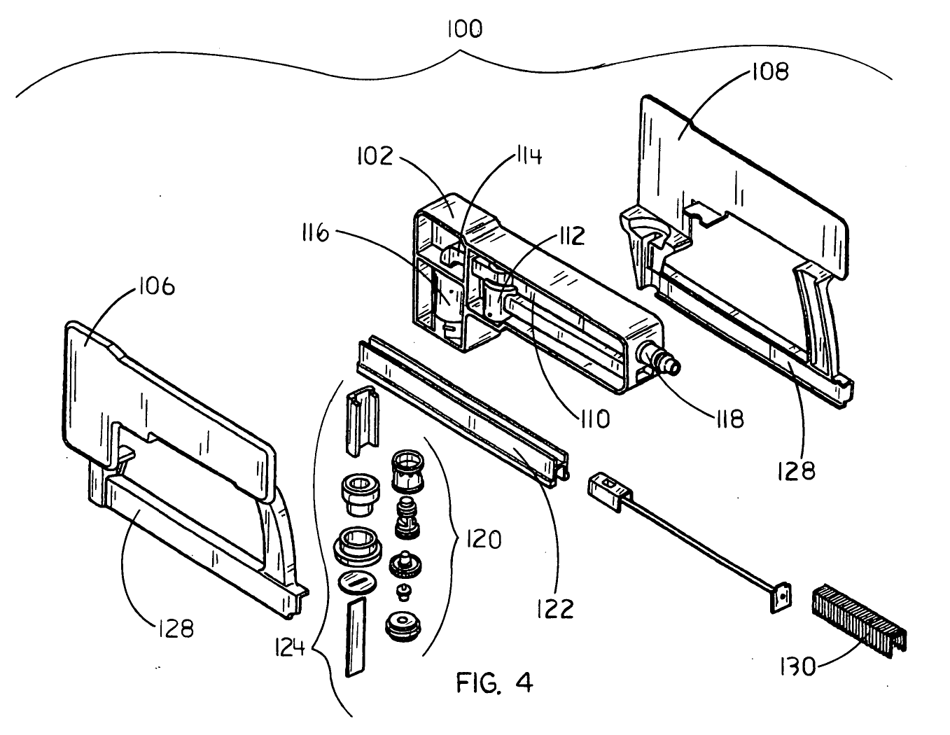

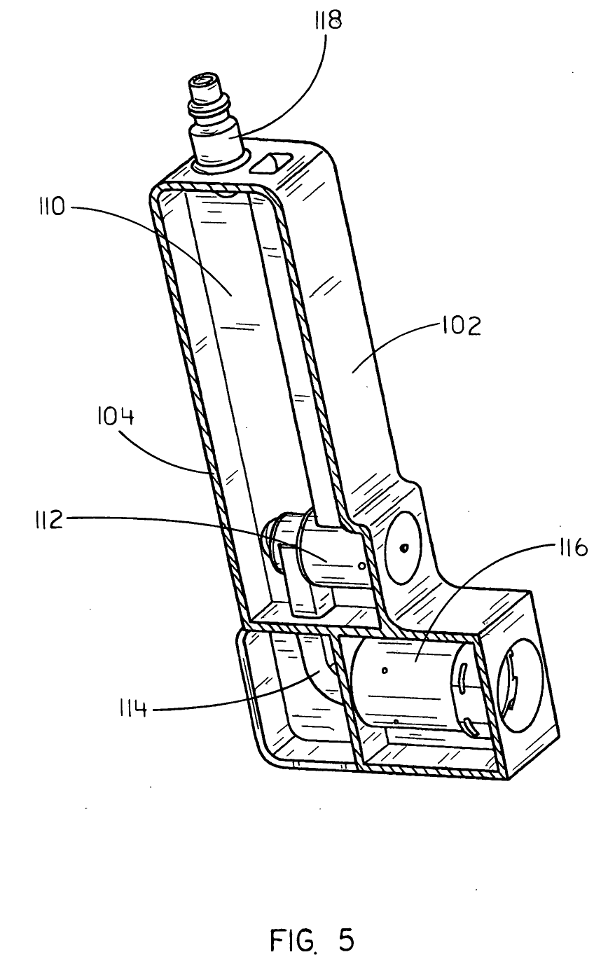

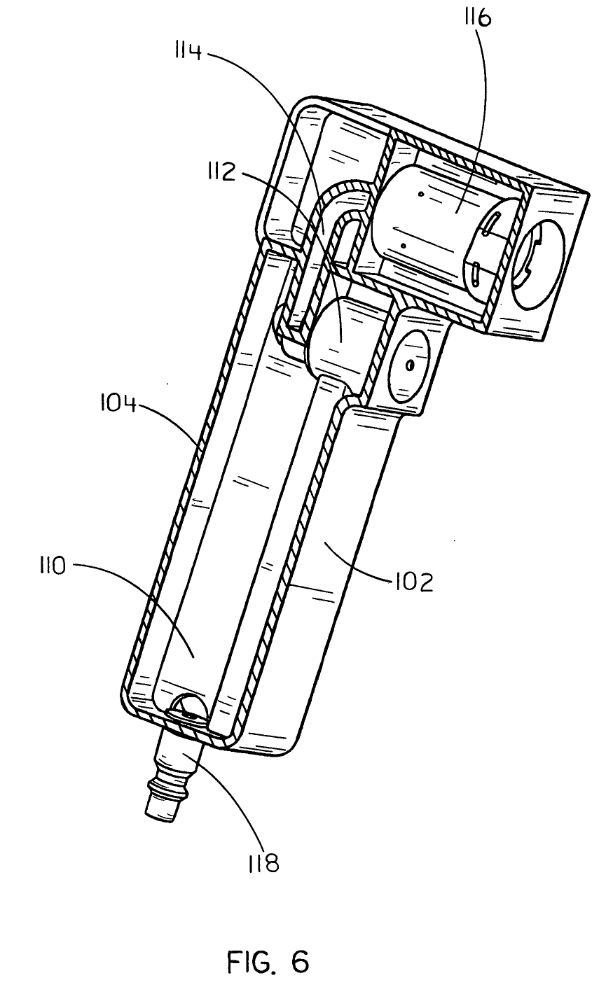

Referring generally to FIGS. 1 through 8, a fastener device embodied as a pneumatic stapler (nailer) 100 is described in accordance with exemplary embodiments of the present invention. However, while a fastener device embodied as a pneumatic stapler (nailer) is described, those of skill in the art will appreciate that other types of fastener devices such as combustion nailers, combustion staplers, palm nailers, and the like, may be manufactured in accordance with the present invention without departing from the spirit and scope thereof.

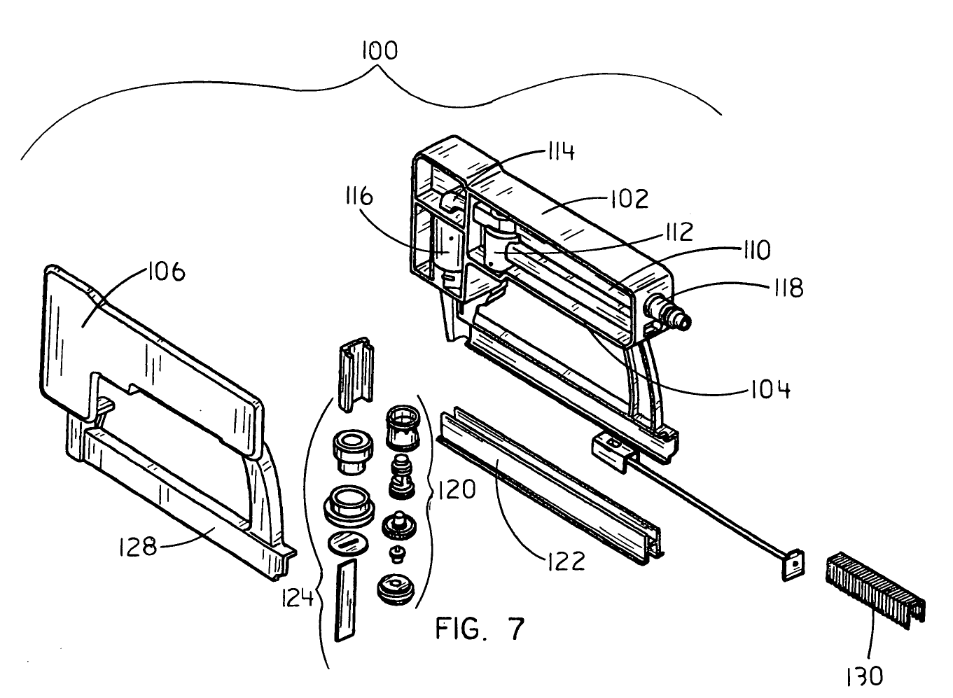

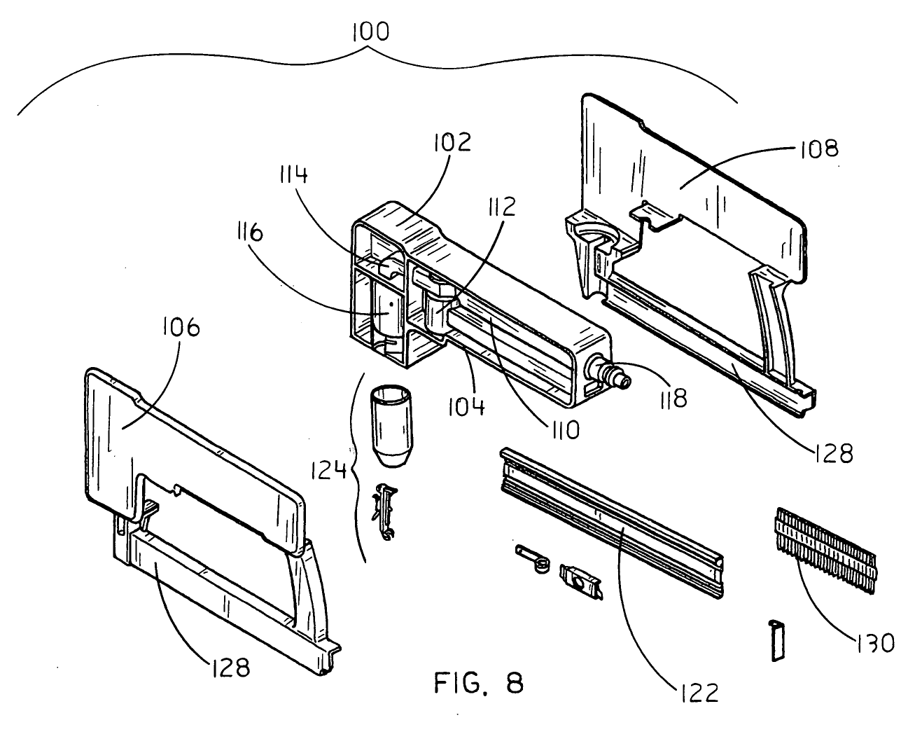

In the embodiment illustrated in FIGS. 1 through 6, a pneumatic stapler 100 is shown which includes a main housing portion (e.g., a central housing) 102 with seal surfaces 104 sealed by first side housing portion 106 and second side housing portion 108. In another embodiment, illustrated in FIG. 7, a pneumatic stapler 100 is shown which includes a main housing portion 102 with seal surfaces 104 sealed by side housing portion 106. In a further embodiment, illustrated in FIG. 8, a pneumatic nailer 100 is shown which includes a main housing portion (e.g., a central housing) 102 with seal surfaces 104 sealed by first side housing portion 106 and second side housing portion 108.

In exemplary embodiments, the main housing portion 102 is molded plastic and generally L-shaped. As molded plastic, internal components of the pneumatic stapler 100 may be formed as an integral part of the main housing portion 102. For example, in the embodiments illustrated in FIGS. 1 through 8, the internal components may include an intake channel 110, a trigger valve cylinder 112, a transfer channel 114, and a power cylinder 116. In the embodiment illustrated, the intake channel 110 is generally rectangular in shape and provides a passageway for compressed air to flow from an intake nozzle 118 to the trigger valve cylinder 112. The intake nozzle 118 is integrated with the main housing portion 102 and is configured to couple with an air hose, or the like for supplying compressed air to the pneumatic stapler 100. The trigger valve cylinder 112 is positioned proximal to a ninety-degree bend in the main housing portion 102 and allows compressed air to flow from the intake channel 110 to the transfer channel 114 when a trigger valve 120 is actuated (e.g., by depressing a trigger button, or the like). The transfer channel 114 is generally L-shaped and guides compressed air from the trigger valve cylinder 112 to the power cylinder 116. The power cylinder 116 is positioned proximal to a magazine 122, and houses a piston valve 124 that propels nails (staples) 130 from the magazine 122 as compressed air thrusts the piston valve 124 forward toward the magazine 122. Internal components such as the piston valve 124 and the trigger valve 120 are coupled to the main housing portion 102 and are held in place by the first side housing portion 106 and the second side housing portion 108 in the embodiments illustrated in FIGS. 1 through 6, and 8.

In embodiments of the invention, the main housing portion 102 is molded with at least two wall members, such as first wall member 132 and second wall member 134, having a web 136 therebetween. Thus, as shown in FIGS. 1 through 6, the two wall members 132 and 134 and the web 136 have a generally “I”-shaped cross section. However, those of skill in the art will appreciate that channels and other features may be molded into the web 136 without departing from the scope and intent of the present invention.

In exemplary embodiments, the first side housing portion 106 and the second side housing portion 108 are also molded plastic and are configured to be fastened to a first side and a second side, generally opposite the first side, of the main housing portion 102, respectively. Preferably, the first side and the second side are generally open for receiving an internal component (e.g., the trigger valve cylinder 112, the power cylinder 116, and the like) of the pneumatic stapler 100 within the main housing portion 102 during assembly of the pneumatic stapler 100. When fastened, the first side housing portion 106 and the second side housing portion 108 seal against the seal surfaces 104, making the main housing portion 102 airtight and enclosing the chambers of the main housing portion 102, such as the intake channel 110 and the transfer channel 114. In one specific embodiment, the first side housing portion 106 and the second side housing portion 108 are welded to the main housing portion 102. In alternative embodiments, the first side housing portion 106 and the second side housing portion 108 may be fastened to the main housing portion 102 by a variety of mechanical fastening assemblies, including, but not limited to, a compression lock assembly, a latch assembly, a snap-fit assembly, and the like. Further, the first side housing portion 106 and the second side housing portion 108 may be utilized to form a handle 126 for grasping the pneumatic stapler 100.

In an exemplary embodiment, the first side housing portion 106 and the second side housing portion 108 are also equipped with an integrated magazine housing 128, for housing the magazine 122. When the first side housing portion 106 and the second side housing portion 108 are fastened (e.g., welded) to the main housing portion 102, the magazine housing 128 encloses and supports the magazine 122. In an advantageous aspect of this configuration, the magazine 122 may be manufactured at a lower cost because the magazine housing 128 is integrated with the first side housing portion 106 and the second side housing portion 108.

Those of skill in the art will recognize that fastener devices in accordance with the present invention are not limited to the specific configurations disclosed herein, but instead may employ form factors having other ornamental or functional design features without departing from the scope and intent of the present invention. For example, FIGS. 1 through 8 illustrate a pneumatic nailer with first side housing portion 106 and possibly second side housing portion 108 holding internal components coupled to main housing portion 102 in place. More specifically, first side housing portion 106 and second side housing portion 108 hold internal components such as the piston valve 124 and the trigger valve 120 in place. However, it is contemplated that the present invention may be implemented with a main housing portion including an integrated piston valve and an integrated trigger valve (and possibly other components as well) held in place by the main housing portion itself.

In other types of fastener devices, including, but not limited to, fastener devices having forms other than those specifically illustrated (e.g., combustion nailers and combustion staplers), the main housing portion 102 and the second side housing portion 108 may be of unitary construction, requiring the utilization of side housing portion 106 for sealing the main housing portion 102. In this configuration, illustrated in FIG. 7, internal components such as the piston valve 124 and the trigger valve 120 are coupled to the main housing portion 102 and are held in place by side housing portion 106. In an exemplary embodiment, side housing portion 106 is also equipped with an integrated magazine housing 128, for housing the magazine 122. When side housing portion 106 is fastened (e.g., welded) to the main housing portion 102, the magazine housing 128 encloses the magazine 122.

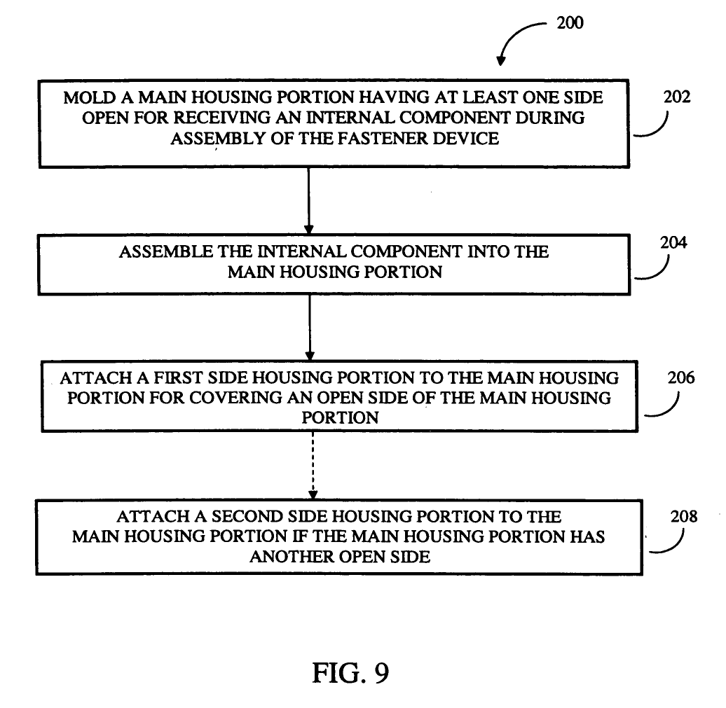

Referring now to FIG. 9, a method of manufacturing a fastener device 200 is described in accordance with an exemplary embodiment of the present invention. In embodiments, the method 200 may be utilized for manufacturing a fastener device such as the pneumatic nailer 100 illustrated in FIGS. 1 through 8. First, a main housing portion is molded, 202. Preferably, the main housing portion has at least one side generally open for receiving an internal component of the fastener device within the main housing portion during assembly of the fastener device, such as the trigger valve cylinder 112 and the power cylinder 116 illustrated in FIGS. 1 through 8. Next, internal components, such as the trigger valve cylinder 112 and the power cylinder 116, are assembled into the main housing portion, 204. Then, a side housing portion, such as first side housing portion 106 illustrated in FIGS. 1 through 8, is attached to the main housing portion for at least substantially covering the side of the main housing portion so that the first side housing portion substantially encloses the internal components within the main housing after assembly of the fastener device, 206. If the main housing portion has two open sides for receiving internal components during assembly of the fastener device, a second side housing portion may be included as well, for substantially enclosing the internal components within the main housing after assembly of the fastener device, 208.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A fastener device, comprising:
a central housing portion having a first side and a second side generally opposite the first side, the first side and the second side being generally open for receiving an internal component of the fastener device within the central housing portion during assembly of the fastener device;
a first side housing portion attached to the first side of the central housing portion for at least substantially covering the first side of the central housing portion; and
a second side housing portion attached to the second side of the central housing portion for at least substantially covering the second side of the central housing portion;
wherein the central housing portion, the first side housing portion and the second side housing portion substantially enclose the internal component after assembly of the fastener device.

2. The fastener device as claimed in claim 1, wherein the central housing portion and at least one of the first side housing portion and the second side housing portion are attached together and sealed for forming a channel for channeling air within the fastener device for driving a fastener into a work piece.

3. The fastener device as claimed in claim 1, wherein the central housing portion is molded with at least two wall members having a web therebetween, the two wall members and the web having a generally “I”-shaped cross section.

4. The fastener device as claimed in claim 1, wherein the central housing portion comprises chambers formed therein for a piston valve for driving a fastener and a trigger valve for actuating the piston valve.

5. The fastener device as claimed in claim 3, wherein the internal part comprises at least one of the piston valve and the trigger valve.

6. The fastener device as claimed in claim 1, further comprising a magazine for holding a plurality of fasteners.

7. The fastener device as claimed in claim 5, wherein the magazine is supported between the first side housing portion and second side housing potion.

8. A fastener device, comprising:
a main housing portion having a side generally open for receiving an internal component of the fastener device within the main housing portion during assembly of the fastener device; and
a side housing portion attached to the side of the main housing portion for at least substantially covering the side of the main housing portion;
wherein the side housing portion substantially encloses the internal component within the main housing after assembly of the fastener device.

9. The fastener device as claimed in claim 8, wherein the main housing portion and the side housing portion are attached together and sealed for forming a channel for channeling air within the fastener device for driving a fastener into a work piece.

10. The fastener device as claimed in claim 8, wherein the main housing portion comprises chambers formed therein for a piston valve for driving a fastener and a trigger valve for actuating the piston valve.

11. The fastener device as claimed in claim 11, wherein the internal part comprises at least one of the piston valve and the trigger valve.

12. The fastener device as claimed in claim 8, further comprising a magazine for holding a plurality of fasteners.

13. The fastener device as claimed in claim 12, wherein the magazine is at least partially supported by the side housing potion.

14. A method of manufacturing a fastener device, comprising:
molding a main housing portion, the main housing portion including a first side generally open for receiving an internal component of the fastener device within the main housing portion during assembly of the fastener device;
assembling the internal component into the main housing portion; and
attaching a side housing portion to the main housing portion for at least substantially covering the first side of the main housing portion so that the side housing portion substantially encloses the internal component within the main housing after assembly of the fastener device.

15. The method as claimed in claim 14, wherein the main housing portion includes a second side opposite the first side, the second side being generally open for receiving an internal component of the fastener device within the main housing portion during assembly of the fastener device.

16. The method as claimed in claim 15, further comprising attaching a second side housing portion to the main housing portion opposite the first side housing portion, the second side housing portion for at least substantially covering the second side of the main housing portion.

17. The method as claimed in claim 16, wherein the main housing portion and at least one of the first side housing portion and the second side housing portion are attached together and sealed for forming a channel for channeling air within the fastener device for driving a fastener into a work piece.

18. The method as claimed in claim 14, wherein molding the main housing portion comprises molding chambers for a piston valve for driving a fastener and a trigger valve for actuating the piston valve.

19. The method as claimed in claim 14, wherein the internal part comprises at least one of the piston valve and the trigger valve.

20. The method as claimed in claim 14, further comprising installing a magazine for holding a plurality of fasteners, the magazine being supported between the first side housing portion and the second side housing potion.
